(19) United States
(12) Patent Application Publication
(10) Pub. No.: US 2026/0214381 A1
(43) Pub. Date: Jul. 23, 2026

(54) MICROPHONE CIRCUIT

(71) Applicant: AAC Technologies Pte. Ltd., Singapore (SG)

(72) Inventor: Dong Han, Singapore (SG)

(21) Appl. No.: 19/315,801

(22) Filed: Sep. 1, 2025

(30) Foreign Application Priority Data
Jan. 21, 2025 (CN) 202510096031.X

(51) Int. Cl. H04R 3/00; G05F 1/575; H02M 3/07

(52) U.S. Cl. CPC H04R 3/00; G05F 1/575; H02M 3/07; H04R 2201/003

(57) ABSTRACT

A microphone circuit is provided, including: a charge pump module connected to a first end of a microphone, configured to receive a preset first voltage and generate a first bias voltage based on the first voltage, and output the first bias voltage to the microphone; an amplification module connected to a second terminal of the microphone, configured to receive a voltage signal output by the microphone, amplify the voltage signal, and output the amplified signal as an output signal of the microphone circuit; and a voltage division module connected to the second end of the microphone and the amplification module, configured to receive the first voltage, divide the first voltage to generate a second bias voltage, output the second bias voltage to the microphone, and further output the second bias voltage as a bias voltage to the amplification module.

### TECHNICAL FIELD

The present application relates to the technical field of circuitry, and more particularly to a microphone circuit.

### BACKGROUND

A MEMS microphone circuit mainly includes a MEMS (microelectromechanical systems) microphone and an ASIC (application-specific integrated circuit) module, which are electrically connected to convert acoustic signals into electrical signals, thereby enabling the microphone function. Specifically, the ASIC module provides the MEMS microphone with a high bias voltage and a low bias voltage to drive the MEMS microphone to convert acoustic signals into electrical signals.

The sensitivity of the MEMS microphone is proportional to a difference between the high bias voltage and the low bias voltage. In the related art, the high bias voltage and the low bias voltage of the MEMS microphone are independently controlled. Adjusting either bias voltage results in a change in the voltage difference between the high and low bias voltages, thereby affecting the sensitivity of the MEMS microphone. Attempting to adjust the high and low bias voltages independently while maintaining the voltage difference increases the complexity of circuit design. However, when the MEMS microphone operates over a wide supply voltage range, the supply voltage may vary. In such cases, in order to maintain the AOP (acoustic overload point) of the microphone circuit, the output voltage of the MEMS microphone circuit needs to be adjusted by changing the low bias voltage, such that the output voltage remains at half of the supply voltage of the MEMS microphone. This is because the AOP of the MEMS microphone circuit is maximized when its output voltage is equal to half the supply voltage. However, changing the low bias voltage also alters the voltage difference between the high and low bias voltages, thereby causing a deviation in the sensitivity of the MEMS microphone.

Accordingly, a new microphone circuit is desired to solve the above-described technical problems.

### SUMMARY

An objective of the present invention is to provide a microphone circuit to solve the above-described technical problems.

A microphone circuit is provided according to the present invention. The microphone circuit includes: a charge pump module, connected to a first end of an external microphone, configured to receive a preset first voltage, to generate a first bias voltage required for operation of the microphone based on the first voltage, and to output the first bias voltage to the microphone; an amplification module, connected to a second end of the microphone, configured to receive a voltage signal output by the microphone, to amplify the voltage signal and to output the amplified voltage signal as an output signal of the microphone circuit; and a voltage division module, connected to the second end of the microphone and to the amplification module, configured to receive the first voltage, to divide the first voltage to generate a second bias voltage required for operation of the microphone and to output the second bias voltage to the microphone, and to output the second bias voltage to the amplification module as a bias voltage of the amplification module.

As an improvement, the charge pump module comprises at least one stage of cascaded charge pumps, each stage having an output terminal connected to an input terminal of a next stage, where an input terminal of a first-stage charge pump is grounded, and an output terminal of a final-stage charge pump is connected to the first end of the microphone. A reference voltage of the first-stage charge pump is the first voltage, and reference voltages of charge pumps subsequent to the first-stage charge pump are preset.

As an improvement, a ratio of the second bias voltage output by the voltage division module to the first voltage received by the voltage division module is equal to a ratio of an output voltage of the first-stage charge pump to the first voltage received by the first-stage charge pump.

As an improvement, each of the charge pumps comprises an enable terminal, and the enable terminal is configured to receive a corresponding enable signal, for controlling the charge pump. The charge pump is configured to, in response to the enable signal being at a first level, adjust an input voltage received by the charge pump based on a reference voltage received by the charge pump and output the adjusted input voltage as an output voltage; and the charge pump is configured to output the input voltage as the output voltage, in response to the enable signal being at a second level.

As an improvement, the amplification module comprises at least one stage of cascaded amplifiers, each stage having an output terminal connected to an input terminal of a next stage, an input terminal of a first-stage amplifier being connected to the second end of the microphone and to the voltage division module, and an output terminal of a final-stage amplifier being configured to output the output signal of the microphone circuit.

As an improvement, the microphone circuit further includes a low dropout linear regulator module, configured to be connected to a power supply, to regulate a voltage from the power supply to obtain the first voltage, and to output the first voltage to the charge pump module and the voltage division module.

As an improvement, the low dropout linear regulator module comprises: a linear regulator unit configured to be connected to the power supply and to regulate the voltage from the power supply to output the first voltage; and a feedback unit configured to receive the first voltage and to perform voltage division on the first voltage to generate a feedback voltage. The linear regulator unit is further configured to receive the feedback voltage and a preset first reference voltage, and to linearly adjust the first voltage based on the feedback voltage and the first reference voltage.

As an improvement, the low dropout linear regulator module further comprises: a voltage divider filter unit configured to be connected to the power supply and to perform voltage division and filtering on the voltage from the power supply to output the first reference voltage.

As an improvement, the microphone is a MEMS microphone.

The present invention provides the following advantageous effects. The microphone circuit provided in the present invention applies a first voltage to both a charge pump module and a voltage division module to respectively obtain a first bias voltage and a second bias voltage. In this manner, both the first bias voltage output by the charge pump module and the second bias voltage output by the voltage division module vary in response to changes in the first voltage. As a result, a difference between the first bias voltage and the second bias voltage remains constant as the first voltage changes. The microphone circuit provided in the present invention allows simultaneous altering the first bias voltage and the second bias voltage by regulating the first voltage. That is, when either bias voltage is changed, the other bias voltage varies accordingly. This prevents the deviation in the sensitivity of the MEMS microphone resulted from a change in the difference between the first and second bias voltages when either of the first and second bias voltages is changed independently. Thus, when the supply voltage of the microphone circuit varies, the second bias voltage can be adjusted by changing the first voltage, thereby adjusting the output voltage of the amplification module to remain approximately at half of the supply voltage. This ensures that the entire microphone circuit maintains a high acoustic overload point (AOP) even as the supply voltage changes. Furthermore, because the first bias voltage varies with the second bias voltage, the difference between the first and second bias voltages remains constant, and the sensitivity of the microphone is not affected by the adjustment of the AOP.

### BRIEF DESCRIPTION OF THE DRAWINGS

FIG. 1 is a schematic diagram of a microphone circuit according to an embodiment of the present invention;

FIG. 2 is a schematic diagram of the microphone circuit according to another embodiment of the present invention;

FIG. 3 is a schematic diagram of the microphone circuit according to another embodiment of the present invention;

FIG. 4 is a schematic diagram of the microphone circuit according to another embodiment of the present invention;

FIG. 5 is a schematic diagram of the microphone circuit according to another embodiment of the present invention; and

FIG. 6 is a schematic diagram of the microphone circuit according to another embodiment of the present invention.

### DETAILED DESCRIPTION OF THE EMBODIMENTS

The present invention will be further described in detail below with reference to the drawings and embodiments.

It should be noted that in the embodiments of the present invention, the term "connection" can be understood as an electrical connection. The connection between two electrical components may be either a direct or an indirect connection. For example, when A is connected to B, it can refer to either a direct connection between A and B, or an indirect connection between A and B via one or more other electrical components.

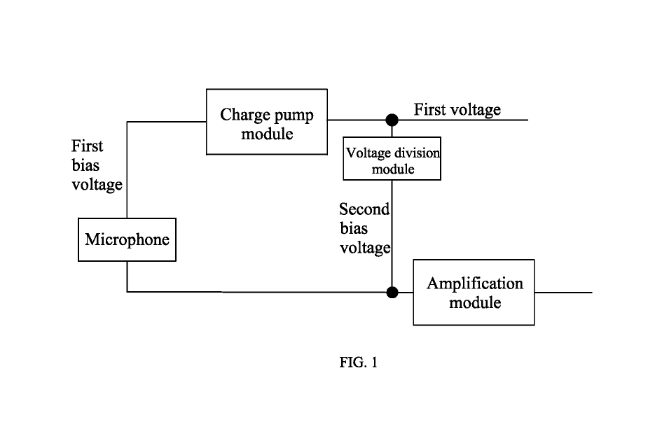

A microphone circuit is provided according to an embodiment of the present invention. FIG. 1 is a schematic diagram of the microphone circuit according to the embodiment of the present invention. As shown in FIG. 1, the microphone circuit provided in this embodiment includes a charge pump module, a voltage division module, and an amplification module.

The charge pump module is connected to a first end of an external microphone. The charge pump module is configured to receive a preset first voltage and generate a first bias voltage required for the operation of the microphone, which is then output to the microphone. Optionally, the charge pump module is configured to step up the first voltage to obtain a first bias voltage, i.e., a high voltage. The output terminal of the charge pump is connected to the first end of the microphone to supply the first bias voltage to the first end of the microphone. The charge pump module receives the first voltage and generates the first bias voltage based on the first voltage.

The voltage division module is connected to a second end of the microphone and to the amplification module. The voltage division module is configured to receive the first voltage, and divide the first voltage to generate a second bias voltage required for the operation of the microphone, and output the second bias voltage to the microphone. The second bias voltage is also provided as a bias voltage to the amplification module. Optionally, an output terminal of the voltage division module is connected to the second end of the microphone and an input terminal of the amplification module, to supply the second bias voltage. i.e., a low voltage, thereto. An input terminal of the voltage division module receives the first voltage and divides the first voltage to obtain the second bias voltage.

The amplification module is connected to a second end of the microphone and is configured to receive a voltage signal output by the microphone, amplify the voltage signal, and output the amplified voltage signal as an output signal of the microphone circuit. Optionally, an input terminal of the amplification module is connected to the second end of the microphone to receive the voltage signal output by the microphone. The input terminal of the amplification module is also connected to an output terminal of the voltage division module to receive a bias voltage output by the voltage division module, which serves as the direct current input voltage of the amplification module. The output terminal of the amplification module amplifies the voltage signal from the microphone and output the amplified voltage signal. For the microphone circuit, when the voltage output by the amplification module reaches approximately half of the supply voltage of the microphone circuit, the entire microphone circuit achieves its maximum AOP (acoustic overload point). In view of this, in the present invention the second bias voltage is used as the bias voltage of the amplification module, so that the second bias voltage can be adjusted by regulating the first voltage when the supply voltage of the microphone circuit changes, thereby adjusting the output voltage of the amplification module to maintain it at approximately half of the supply voltage of the microphone circuit.

In some preferred embodiments of the present invention, the external microphone in the microphone circuit in is a MEMS microphone.

In one embodiment of the present invention, in the microphone circuit the charge pump module receives the first voltage through a signal input port. In this case, the first bias voltage output by the charge pump module is given by VH = Vref × K + V1. The second bias voltage output by the voltage division module is given by: VL = V1 × H. The difference between the first bias voltage and the second bias voltage is: VH − VL = Vref × K + V1 − V1 × H. VH represents the first bias voltage, Vref represents a reference voltage of the charge pump module, K represents an efficiency factor of the charge pump module, V1 represents the first voltage, VL represents the second bias voltage, and H represents a voltage division coefficient of the voltage division module. Therefore, it can be seen that in the microphone circuit according to the embodiment of the present invention the extent to which the difference between the first bias voltage and the second bias voltage can change following the first voltage can be controlled by adjusting the voltage division coefficient H. Furthermore, when the voltage division coefficient of the voltage division module is 1, the difference between the first bias voltage and the second bias voltage will always remain unchanged, such that the sensitivity of the MEMS microphone does not shift with the bias voltages in the microphone circuit. When the supply voltage of the microphone circuit changes, the microphone circuit adjusts the output voltage of the amplification module in synchronization by adjusting the second bias voltage. In this case, the sensitivity of the MEMS microphone will not shift with the change in the supply voltage.

In other embodiment of the present invention, the charge pump module receives the first voltage through a reference voltage input port, while a signal input port of the charge pump module receives an input voltage from an external circuit. In this case, the first bias voltage output by the charge pump module is: VH = V1 × K + V0, and the second bias voltage output by the voltage division module is: VL = V1 × H. The difference between the first bias voltage and the second bias voltage is: VH − VL = V1 × K + V0 − V1 × H. VH represents the first bias voltage, V1 represents the first voltage, i.e., the reference voltage of the charge pump module, K represents the efficiency factor of the charge pump module, V0 represents the input voltage from the external circuit, VL represents the second bias voltage, and H represents the voltage division coefficient of the voltage division module. It can be seen that, in these embodiments the extent to which the difference between the first bias voltage and the second bias voltage changes following the first voltage is determined by the difference between the efficiency factor K of the charge pump module and the voltage division coefficient H of the voltage division module. When the difference between the efficiency factor K and the voltage division coefficient H is zero, the difference between the first bias voltage and the second bias voltage will always remain constant. Therefore, the sensitivity of the MEMS microphone does not shift with the bias voltages in the microphone circuit. When the supply voltage of the microphone circuit changes, the microphone circuit adjusts the output voltage of the amplification module in synchronization by adjusting the second bias voltage. In this case, the sensitivity of the MEMS microphone will not shift with the change in the supply voltage. Optionally, the embodiments of the present invention does not impose any limitation on the type or structure of the external circuit, as long as the external circuit is applicable to the microphone circuit.

In an embodiment, the microphone operates over a relatively wide range of the supply voltage. For example, the supply voltage of the microphone ranges from 0.9 V to 3.6 V, in the embodiment of the present invention the second bias voltage can be adjusted by regulating the first voltage as the supply voltage changes. Since the second bias voltage is also the direct current input voltage of the amplification module, changing the second bias voltage also changes the output voltage of the amplification module, so that the output voltage can always be maintained at approximately half of the supply voltage of the microphone circuit, thereby ensuring that the entire microphone circuit always has a relatively high acoustic overload point. In addition, since the first bias voltage also varies along with the second bias voltage, the microphone circuit can always maintain a constant difference between the first bias voltage and the second bias voltage, such that the sensitivity of the microphone does not shift due to the adjustment of the acoustic overload point.

It can be understood that, in the embodiments of the present invention the charge pump module, the voltage division module, and the amplification module are electrically connected to the external MEMS microphone.

In addition, the embodiments of the present invention do not impose any limitation on the source of the first voltage. By way of example, the first voltage may be set as the supply voltage of the MEMS microphone circuit. In this case, when the MEMS microphone operates over a wide range of the supply voltage and the supply voltage changes, the first bias voltage and the second bias voltage will also change accordingly, without significantly affecting the sensitivity of the MEMS microphone. By way of example, the first voltage may also be from a voltage regulation circuit, so as to provide the MEMS microphone circuit with a first bias voltage and a second bias voltage having a relatively proper power supply rejection ratio (PSRR). By way of example, the first voltage may further be from a voltage regulation circuit configured to regulate the supply voltage to obtain the first voltage. The above examples are merely provided to illustrate that the embodiments of the present invention do not limit the source of the first voltage, and shall not be construed as indicating that the first voltage can only be obtained in the above three example ways.

It can be understood that, in the embodiments of the present invention no specific structural limitations are imposed on the voltage division module, since the voltage division module is a relatively mature component in the existing technical field, and the focus and intended objective of the embodiments of the present invention is not to innovate or explore in depth the specific structure of such units. By way of example, a basic voltage division module may be configured to include a voltage divider, or include a voltage division circuit composed of resistive elements.

The microphone circuit in the embodiments of the present invention enables simultaneous adjustment of the first bias voltage and the second bias voltage by regulating the first voltage. In other words, when either one of the bias voltages is adjusted, the other bias voltage will change accordingly, thereby solving the technical problem that the difference between the first bias voltage and the second bias voltage is prone to change due to the adjustment of either bias voltage, which would result in deviation in the sensitivity of the MEMS microphone.

The microphone circuit in the present invention is applicable to a microphone circuit with an adjustable supply voltage. In this way, when the supply voltage of the microphone circuit changes, the second bias voltage can be adjusted by changing the first voltage, and the output voltage of the amplification module can then be adjusted to approximately half of the supply voltage by adjusting the second bias voltage. Since the first bias voltage also changes along with the second bias voltage, the microphone circuit of the present invention can ensure that, when the supply voltage changes, the microphone circuit maintains a high AOP, while also ensuring that the sensitivity of the microphone does not deviate.

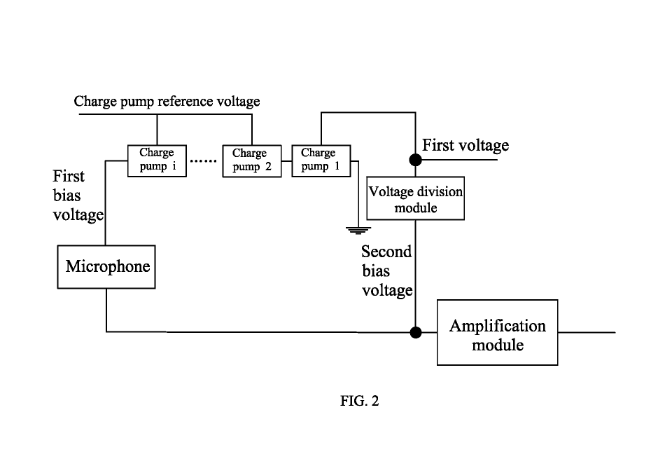

FIG. 2 is a schematic diagram of the microphone circuit according to some preferred embodiments of the present invention. As shown in FIG. 2, the charge pump module includes at least one stage of cascade-connected charge pumps, i.e., a charge pump 1 to a charge pump i, where i ≥ 1. An output terminal of one charge pump is connected to the input terminal of the next-stage charge pump , and the input terminal of the first-stage charge pump (i.e., the charge pump 1) is grounded (GND). The output terminal of the last-stage charge pump (i.e., the charge pump i) is connected to a first end of the microphone. In this configuration, the reference voltage of the first-stage charge pump is the first voltage. The reference voltages of the charge pumps in all stages following the first stage are preset charge pump reference voltages. Optionally, as shown in FIG. 2, the first bias voltage output by the charge pump module is VH = V1 × K₁ + V_{ref} × K₂ + V_{ref} × K₃ + ... + V_{ref} × K_{N}, and the second bias voltage output by the voltage division module is VL = V1 × H. The difference between the first bias voltage and the second bias voltage is VH − VL = V1 × K₁ − V1 × H + _{Vref} × K₂ + V_{ref} × K₃ + ... + V_{ref} × K_{N}. VH represents the first bias voltage, V1 represents the first voltage, i.e., the reference voltage of the first-stage charge pump, V_{ref} represents the preset charge pump reference voltage, which is constant for all charge pumps after the first stage and is supplied by an external circuit such as a linear voltage regulator. Kᵢ represents the efficiency factor of the i-th stage charge pump, where 1 ≤ i ≤ N, and N is the number of cascaded stages in the charge pump module. VL represents the second bias voltage, and H represents the voltage division coefficient of the voltage division module. It can be seen that in the microphone circuit of the embodiment of the present invention, the extent to which the difference between the first bias voltage and the second bias voltage changes flowing the first voltage is determined by the difference between the efficiency factor K1 of the first-stage charge pump and the voltage division coefficient H of the voltage division module.

In some embodiments of the present invention, a ratio of the second bias voltage output by the voltage division module to the first voltage received by the voltage division module is equal to a ratio of the output voltage of the first-stage charge pump to the first voltage received by the first-stage charge pump. Optionally, the ratio of the second bias voltage output by the voltage division module to the first voltage received by the voltage division module is the voltage division coefficient H of the voltage division module. The signal input terminal of the first-stage charge pump is grounded, and the first voltage is input to the first-stage charge pump as the reference voltage. That is, the first-stage charge pump has no input voltage, and its output voltage is V1 × K1. The ratio of the output voltage of the first-stage charge pump to the first voltage received by the first-stage charge pump is K1. The difference between the first bias voltage and the second bias voltage is VH − VL = V1 × K₁ − V1 × H + V_{ref} × K₂ + V_{ref} × K₃ + ... + V_{ref} × K_{N}. When H = K₁, then VH − VL = V_{ref} × K₂ + V_{ref} × K₃ + ... + V_{ref} × K_{N}. That is, the difference between the first bias voltage and the second bias voltage is constant, and will not change following the first voltage.

The microphone circuit in the embodiments of the present invention inputs the first voltage as the reference voltage of the first-stage charge pump. In this way, the difference between the first bias voltage and the second bias voltage is determined by the difference between the efficiency factor K1 of the first-stage charge pump and the voltage division coefficient H of the voltage division module. When the efficiency factor K1 of the first-stage charge pump is equal to the voltage division coefficient H of the voltage division module, the difference between the first bias voltage and the second bias voltage will not vary with the first voltage. As a result, the sensitivity of the MEMS microphone will not shift with variations in the bias voltages, thereby solving the problem in which the difference between the first bias voltage and the second bias voltage is prone to change due to adjustment of either bias voltage, which would result in deviation in the sensitivity of the MEMS microphone.

In some embodiments, the microphone circuit includes a charge pump module where each stage of the charge pump includes an enable terminal. The enable terminals of the respective charge pumps are configured to receive corresponding enable signals, with each enable signal being used to control its corresponding charge pump. When the enable signal is at a first level, the charge pump adjusts its input voltage according to the reference voltage it receives, and outputs the adjusted input voltage as the output voltage. In this case, the output voltage of the charge pump is Vₒᵤₜ = Vᵢₙ + V_{ref} × K. When the enable signal is at a second level, the charge pump outputs the input voltage as the output voltage. In this case, the output voltage of the charge pump is Vₒᵤₜ = Vᵢₙ. Optionally, the first level may be either high or low, and the second level may be the opposite.

It can be understood that the embodiments of the present invention do not impose any limitations on the source of the enable signal. For example, the enable signal may be generated by an existing level generation circuit.

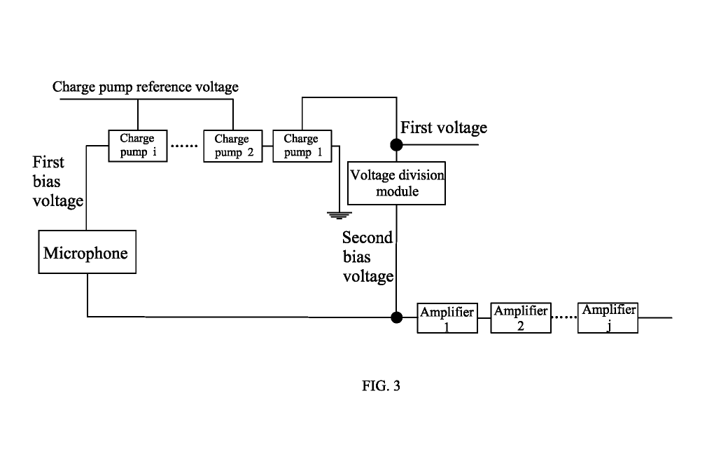

FIG. 3 shows a schematic diagram of the microphone circuit according to some embodiments of the present invention. As shown in FIG. 3, the amplification module includes at least one stage of coupled amplifiers, i.e., amplifiers 1 to j coupled in series, where j ≥ 1. The output terminal of one amplifier is connected to the input terminal of the next amplifier, and the input terminal of the first-stage amplifier, i.e., the amplifier 1, is connected to the second terminal of the microphone and the voltage division module. The output terminal of the last-stage amplifier (i.e., amplifier j) is used to output the output signal of the microphone circuit. The microphone circuit in these embodiments of the present invention can significantly improve the circuit gain and stabilize the signal processing process through multi-stage amplification. It can be also flexible and configured to adapt to different scenarios, optimizing the overall performance of the circuit, so that the output signal can better meet subsequent requirements.

The microphone circuit in some embodiments of the present invention includes a two-stage coupled amplifier in the amplification module, thereby performing two-stage amplification on the voltage signal output by the microphone.

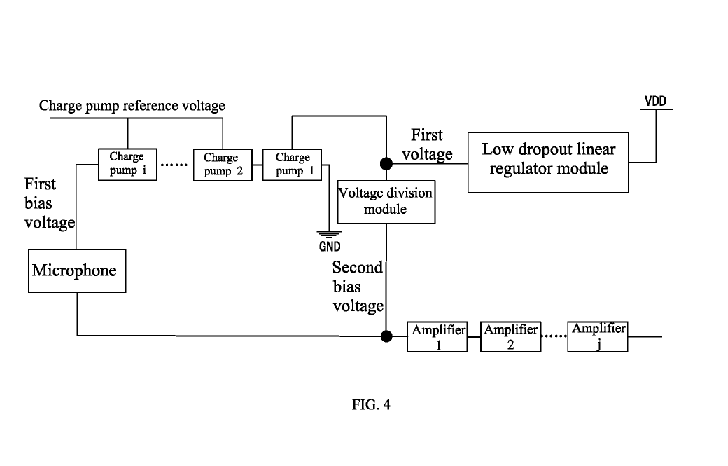

FIG. 4 shows a schematic diagram of the microphone circuit according to some embodiments of the present invention. As shown in FIG. 4, the microphone circuit of the present invention further includes a low dropout linear regulator module. The input terminal of the low dropout linear regulator module is connected to the power supply VDD, and the output terminal of the low dropout linear regulator module is connected to the input terminals of both the charge pump module and the voltage division module. In this way, the low dropout linear regulator module performs linear voltage regulation on the supply voltage to obtain the first voltage, which is then output to the charge pump module and the voltage division module.

The microphone circuit in the embodiments of the present invention obtains the first voltage through processing the supply voltage by the low dropout linear regulator module. In this way, when the microphone circuit operates over a wide range of the supply voltage, the first voltage will also change in response to the supply voltage, thereby causing the AOP of the microphone circuit to vary in synchronization with the supply voltage. In addition, the sensitivity of the microphone circuit will not deviate.

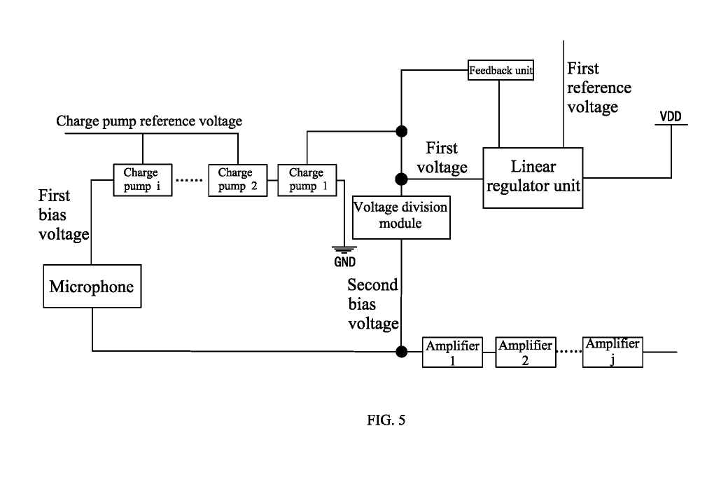

FIG. 5 shows a schematic diagram of the microphone circuit according to some embodiments of the present invention. As shown in FIG. 5, the low dropout linear regulator module includes a linear regulator unit and a feedback unit.

The input terminal of the linear regulator unit is connected to the power supply VDD, and the output terminal of the linear regulator unit is connected to both the charge pump module and the voltage division module, thereby performing voltage regulation on the supply voltage and outputting the first voltage to the charge pump module and the voltage division module. The feedback unit is connected to the linear regulator unit and is configured to receive the first voltage and perform voltage division to generate a feedback voltage. Furthermore, the linear regulator unit is also configured to receive the feedback voltage and a preset first reference voltage, and to linearly adjust the first voltage based on the feedback voltage and the first reference voltage, thereby enabling the first voltage to be adjusted in a timely manner as soon as the supply voltage changes. Optionally, the microphone circuit in the embodiments of the present invention can adjust the first voltage by altering the first reference voltage and/or the voltage division coefficient of the feedback unit.

It should be noted that in the embodiments of the present invention, the term "and/or" describes the relationship between the associated objects, indicating that three possible relationships may exist. For example, "A and/or B" can represent the following three cases: A exists alone, both A and B exist together, and B exists alone. Additionally, the character "/" generally represents an "or" relationship between the associated objects, unless otherwise specified.

It can be understood that in the embodiments of the present invention, no specific structural limitations are imposed on the linear regulator unit and the feedback unit. This is because both the linear regulator unit and the feedback unit are relatively mature in the existing technical field, and the focus and objectives of the present invention are not directed towards innovating or exploring the specific structures of these two units. By way of example, a basic linear regulator unit can be configured to include an operational amplifier and a transistor. The non-inverting input terminal and the inverting input terminal of the operational amplifier are configured to receive the feedback voltage and the first reference voltage, respectively. The output terminal of the operational amplifier is connected to the gate of the transistor, the source of the transistor is connected to the power supply, and the drain of the transistor outputs the first voltage. A basic feedback unit can be configured as a voltage division circuit/divider, which performs voltage division on the first voltage and outputs the divided result as the feedback voltage to the operational amplifier. The above is merely one configuration of the linear regulator unit and feedback unit, and does not imply that the functionality of these units in the embodiments of the present invention can only be achieved through this structure.

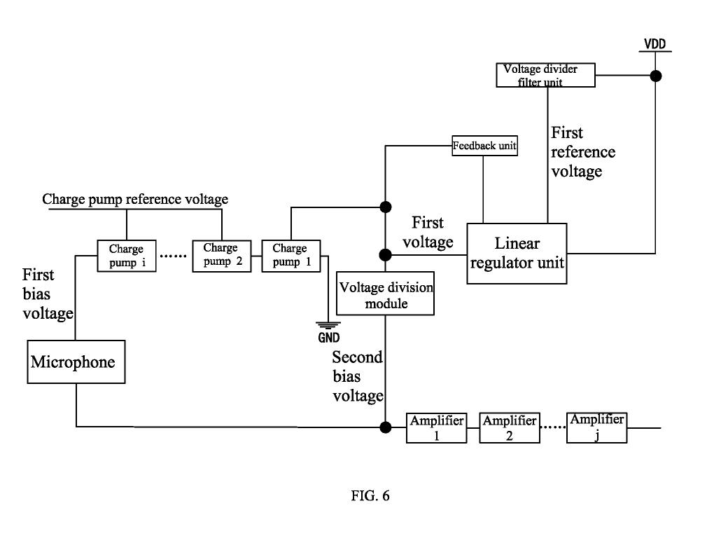

FIG. 6 shows a schematic diagram of the microphone circuit according to some embodiments of the present invention. As shown in FIG. 6, the low dropout linear regulator module further includes a voltage divider filter unit. The input terminal of the voltage divider filter unit is connected to the power supply VDD, and the output terminal is connected to the linear regulator unit, thereby performing voltage division and filtering on the supply voltage to output the first reference voltage. Optionally, the first reference voltage also changes with the supply voltage. The supply voltage is divided and filtered to produce a first reference voltage that varies proportionally with the supply voltage. This allows the first voltage output by the linear regulator unit to also change proportionally with the supply voltage. Furthermore, the first reference voltage obtained after voltage division and filtering possesses a certain power supply rejection ratio (PSRR), thereby ensuring that the first voltage obtained by regulating the first reference voltage also exhibits a proper PSRR.

In some embodiments of the present invention, the first voltage output by the low dropout linear regulator module is 0.95 times the supply voltage. The voltage division coefficient of the voltage division module and the efficiency factor of the charge pump module are both 0.5. In this case, the second bias voltage VL is 0.95VDD × 0.5 = 0.475VDD, where VDD represents the supply voltage, and VL represents the second bias voltage. It can be seen that regardless of how the supply voltage changes, the second bias voltage remains approximately 0.5 times the supply voltage. Since the second bias voltage serves as the direct current input voltage for the amplification module, the output voltage of the amplification module will also remain approximately 0.5 times VDD. It should be noted that the relationship between the first voltage output by the low dropout linear regulator module and the supply voltage depends on the specific design and performance of the low dropout linear regulator module.

It can be understood that, in the embodiments of the present invention no specific structural limitations are imposed on the voltage division unit and the filtering unit, since these two units are relatively mature in the existing technical field, and the focus and intended objectives of the embodiments of the present invention do not lie in innovating or delving into the specific structure of these two units. By way of example, the voltage division unit and the filtering unit may be configured to include a voltage divider circuit/component and a filter circuit/component, respectively.

Merely embodiments of the present invention are described above. It should be noted that a person of ordinary skill in the art may still make improvements without departing from the inventive concept of the present invention, and such improvements shall fall within the scope of protection of the present invention.

What is claimed is:

1. A microphone circuit, comprising:
a charge pump module, connected to a first end of an external microphone, configured to receive a preset first voltage, to generate a first bias voltage required for operation of the microphone based on the first voltage, and to output the first bias voltage to the microphone;
an amplification module, connected to a second end of the microphone, configured to receive a voltage signal output by the microphone, to amplify the voltage signal and to output the amplified voltage signal as an output signal of the microphone circuit; and
a voltage division module, connected to the second end of the microphone and to the amplification module, configured to receive the first voltage, to divide the first voltage to generate a second bias voltage required for operation of the microphone and to output the second bias voltage to the microphone, and to output the second bias voltage to the amplification module as a bias voltage of the amplification module.

2. The microphone circuit according to claim 1, wherein the charge pump module comprises at least one stage of cascaded charge pumps, each stage having an output terminal connected to an input terminal of a next stage, wherein an input terminal of a first-stage charge pump is grounded, and an output terminal of a final-stage charge pump is connected to the first end of the microphone; and
wherein a reference voltage of the first-stage charge pump is the first voltage, and reference voltages of charge pumps subsequent to the first-stage charge pump are preset.

3. The microphone circuit according to claim 2, wherein a ratio of the second bias voltage output by the voltage division module to the first voltage received by the voltage division module is equal to a ratio of an output voltage of the first-stage charge pump to the first voltage received by the first-stage charge pump.

4. The microphone circuit according to claim 2, wherein each of the charge pumps comprises an enable terminal, and the enable terminal is configured to receive a corresponding enable signal, for controlling the charge pump; and
wherein the charge pump is configured to, in response to the enable signal being at a first level, adjust an input voltage received by the charge pump based on a reference voltage received by the charge pump and output the adjusted input voltage as an output voltage; and the charge pump is configured to output the input voltage as the output voltage, in response to the enable signal being at a second level.

5. The microphone circuit according to claim 1, wherein the amplification module comprises at least one stage of cascaded amplifiers, each stage having an output terminal connected to an input terminal of a next stage, an input terminal of a first-stage amplifier being connected to the second end of the microphone and to the voltage division module, and an output terminal of a final-stage amplifier being configured to output the output signal of the microphone circuit.

6. The microphone circuit according to claim 1, further comprising:
a low dropout linear regulator module, configured to be connected to a power supply, to regulate a voltage from the power supply to obtain the first voltage, and to output the first voltage to the charge pump module and the voltage division module.

7. The microphone circuit according to claim 6, wherein the low dropout linear regulator module comprises:
a linear regulator unit configured to be connected to the power supply and to regulate the voltage from the power supply to output the first voltage; and
a feedback unit configured to receive the first voltage and to perform voltage division on the first voltage to generate a feedback voltage;
wherein the linear regulator unit is further configured to receive the feedback voltage and a preset first reference voltage, and to linearly adjust the first voltage based on the feedback voltage and the first reference voltage.

8. The microphone circuit according to claim 7, wherein the low dropout linear regulator module further comprises:
a voltage divider filter unit configured to be connected to the power supply and to perform voltage division and filtering on the voltage from the power supply to output the first reference voltage.

9. The microphone circuit according to claim 1, wherein the microphone is a MEMS microphone.
